(19) United States
(12) Patent Application Publication
(10) Pub. No.: US 2012/0279453 A1
(43) Pub. Date: Nov. 8, 2012

(54) DOMED HAY BALE FEEDER COVER

(76) Inventors: Brian Goodhart, Barnesville, OH (US); Christina Goodhart, Barnesville, OH (US)

(21) Appl. No.: 13/100,548

(22) Filed: May 4, 2011

(51) Int. Cl. A01K 1/10

(52) U.S. Cl. 119/58

(57) ABSTRACT

A domed hay bale feeder cover comprising: a circular base unit; a plurality of curved beams attached to said circular base unit, where said plurality of curved beams intersect at a central point; a bolt through said central point affixing each of said curved beams together; a flexible covering placed over said curved beams; and a plurality of stretchable cords, wherein said stretchable cords attach said covering to said circular base unit. In one particular embodiment, the diameter of the circular base unit may equal a diameter of a cattle feeder that is on the subject of the feeder. The curved beams may be soldered at a junction point to the circular base unit. The curved beams may be arranged with a 45-degree separation beam at the junction points.

### CROSS REFERENCE TO OTHER APPLICATIONS

This application claims priority to U.S. Provisional Application Ser. No. 61/330,424 filed on May 3, 2010.

### BACKGROUND OF THE INVENTION

It is commonly known to use a round bale feeder to hold the hay bales to feed livestock and cattle. The feeders allow the animals to have easy and continuous access to the hay while keeping it in a contained location. Owners of livestock know that the animals will not eat the hay if it has been stepped on or is wet. The feeder keeps the food together so that the animals do not step on or defecate on the hay.

A problem in the art is how to keep the hay bales dry during inclement weather. If rain or snow gets on the hay bales the animals will not eat the wet food. This causes waste and extra costs for the cattle owner. Currently, there are limited alternatives to ensure that bales of hay remain dry. U.S. Pat. No. 4,488,565 discloses a flexible covering for a hay bale feeder. This covering has removable braces which are clamped to the top of the feeder. The braces extend upwards and then together to meet at a central point. A cover may be placed over the braces to keep off the rain and snow. A problem with this invention is that the braces are only stabilized by their junction at the top and the cover. This allows for a wobbly and unstable structure.

Accordingly, it would be beneficial to have a hay bale feeder which not only covered the hay but also provided a sturdy and stable structure which will not collapse during inclement weather.

### SUMMARY OF THE INVENTION

The present invention relates to a domed hay bale feeder cover comprising: a circular base unit; a plurality of curved beams attached to said circular base unit, where said plurality of curved beams intersect at a central point; a bolt through said central point affixing each of said curved beams together; a flexible covering placed over said curved beams; and a plurality of stretchable cords, wherein said stretchable cords attach said covering to said circular base unit. In one particular embodiment, the diameter of the circular base unit may equal a diameter of a cattle feeder that is on the subject of the feeder. The curved beams may be soldered at a junction point to the circular base unit. The curved beams may be arranged with a 45-degree separation beam at the junction points.

### BRIEF DESCRIPTION OF THE DRAWINGS

The accompanying drawings illustrate the preferred embodiments of the invention according to the practical application of the principles thereof, and in which:

FIG. 1 is a perspective view of the present invention;

FIG. 2 is a perspective view from the top of the present invention;

FIG. 3 is a side view of the present invention;

FIG. 4 is a perspective view of the present invention including the tarp;

FIG. 5 is a perspective view of the individual components of the present invention, (a) is a perspective view of the circular base unit, (b) is a cross-sectional view of the circular base unit, (c) is a perspective view of a curved beam; (d) is a perspective view of a U-bolt and a strap.

### DETAILED DESCRIPTION

The present invention relates to a bale feeder cover the provides a means to ensure that stored bay hales remain dry while being stored as feed for livestock. The bale feeder cover prevents spoilage that could possibly occur due to weather conditions such as rain, snow or condensation. By the maintaining the feed in a dry condition animals may be more likely to indulge in the feed stored under the feeder cover. Use of the feeder cover according to the present invention helps to eliminate unnecessary costs by not having to buy extra food to compensate for spoilage.

Turning now descriptively to the drawings, in which similar reference characters denote similar elements throughout several views. Referring to FIG. 1, a perspective view of a domed hay bale feeder cover (10) is shown, which may comprise a circular base unit (11) and several curved beams (12) extending upwardly from the base unit (11) which intersect at a central point (13) above a cattle feeder (20). The diameter of the circular base unit (11) may be equal to the diameter of the cattle feeder (20). For example if the feeder (20) has a diameter of 8 feet then the circular base unit (11) will have a diameter of 8 feet as well. The circular base unit (11) and the curved beams (12) may be constructed out of steel, angel iron, flat iron or other metal.

The curved beams (12) may be welded or soldered at a junction point (15) to the circular base unit (11) for strength and stability of the domed hay bale feeder cover (10). The curved beams (12) may be longer than the diameter of the feeder (20) so that when they are attached to the coordinating circular base unit (11) in a bowed fashion. For example, if the feeder (20) has a diameter of 8 feet so will the circular base unit (11) have a diameter of 8 feet, the beam (12) may have a length of 10 feet. The curved beams (12) may have a hole drilled into its central point (13). The hole at the central point (13) may provide a means to join the curved beams (12) with a bolt or other attachment device to ensure stability for the domed hay bale feeder cover (10). With all of the curved beams (12) joined at their central point (13) the domed hay bale feeder cover (10) has a domed shape.

Referring to FIG. 2, a perspective view from the top of the current invention is shown without the feeder (20). The curved beams (12) may be evenly arranged on the circular base unit (11) so that there is a 45-degree separation between the junction points (15). The arrangement of the curved beams (12) along the circular base unit (11), the soldered junction points (15) and the central point (13) secured with a bolt may give greater strength and stability to the entire structure especially during inclement weather which may ensure that the hay bales remain dry and edible.

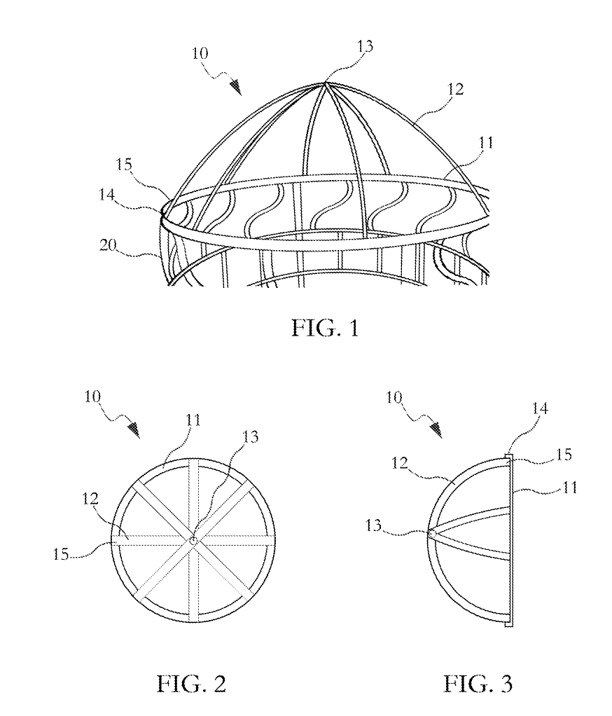

Referring to FIG. 3, a side view of the domed hay bale feeder cover (10), shows the circular base unit (11), the curved beams (12) the central point (13) and a lip (14). FIG. 3 gives a better view of how the curved beams (12) may bow when attached to the circular base unit (11). The lip (14) may be located at the outer edge of the circular base unit (11). The lip (14) may serve as a support to add strength to the junction points (15) where the curved beams (12) abut the circular base unit (11).

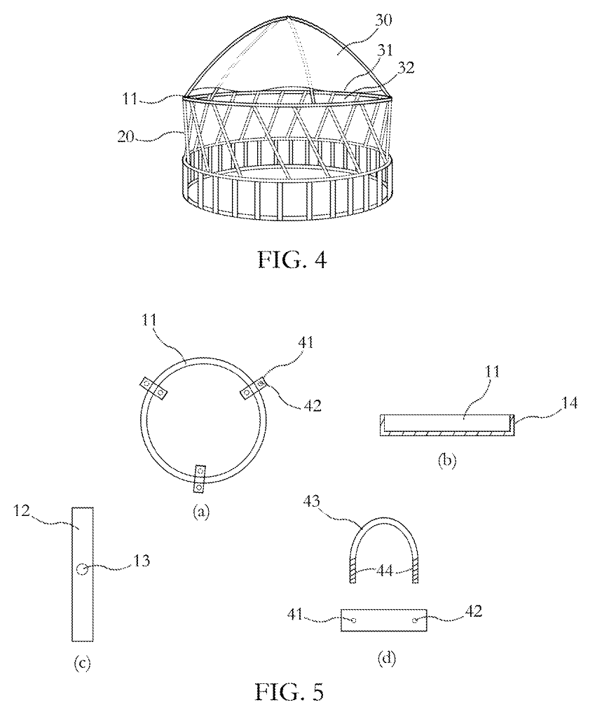

Referring to FIG. 4, a side view of the domed hay bale feeder cover (10) is shown upon the feeder (20) with a tarp (30). The tarp (30) may be draped over the domed hay bale feeder cover (10) as a means to prevent rain and snow from wetting the hay bales (not shown) in the feeder (20). The tarp (30) may have several eyelets (31) to receive an end of an elastic cord (32) for example a bungee cord. The opposing end of the elastic cord (32) may attach to the feeder (20) or the circular base unit (11). The tarp (30) may be made from a waterproof material like canvas, vinyl, polyethylene or various other known waterproof materials.

Referring to FIG. 5, perspective views of the individual elements of the present invention are shown. FIG. 5 (a) shows the circular base unit (11) with several straps (41). The straps (41) may have two holes (42) which may receive the ends of a U-bolt, shown in FIG. 5 (d). FIG. 5 (b) shows a cross-sectional view of the circular base unit (11) with the lip (14). FIG. 5 (c) shows a perspective view from the top of the curved beam (12) with the central hole (13). FIG. 5 (d) is a perspective view of a U-bolt (43) and the strap (41). The strap (41) may have two holes (42). The U-bolt (43) may have two threaded ends (44) which may fit through the holes (42) of the straps (41). In one exemplary embodiment, the U-bolt (43) and straps (41) may be used to attach the domed hay bale feeder cover (10) to the feeder (20) by placing the threaded ends (44) of the U-bolt (43) through the holes (42) and securing the device with a nut (not shown). Other attachment means known in the art may also be used to attach the domed hay bale feeder cover (10) to the feeder (20). The U-bolts (43) may safely and securely stabilize the domed hay bale feeder cover (10) on top of the feeder (20) so that the domed hay bale cover will not detach from the feeder (20) during inclement weather.

The instant invention has been shown and described in what it considers to be the most practical and preferred embodiments. It is recognized, however, that departures may be made there from within the scope of the invention and that obvious modifications will occur to a person skilled in the art.

What is claimed is:

1. A domed hay bale feeder cover comprising:
a. a circular base unit;
b. a plurality of curved beams attached to said circular base unit, where said plurality of curved beams intersect at a central point;
c. a bolt through said central point affixing each of said curved beams together;
d. a flexible covering placed over said curved beams; and
e. a plurality of stretchable cords, wherein said stretchable cords attach said covering to said circular base unit.

2. The domed hay bale feeder cover according to claim 1, where a diameter of the circular base unit equals a diameter of a cattle feeder that is on the subject of the feeder.

3. The domed hay bale feeder cover according to claim 1, wherein the curved beams were soldered at a junction point to the circular base unit.

4. The domed hay bale feeder cover according to claim 1, wherein the curved beams were arranged with a 45-degree separation beam at the junction points.

5. The domed hay bale feeder cover according to claim 1, wherein the circular base unit further includes a lip located at an outer edge of the circular base unit.

6. The domed hay bale feeder cover according to claim 1, further including a tarp, wherein the tarp includes several eyelets to receive an elastic cord.

7. The domed hay bale feeder according to claim 1, further including a plurality of straps wherein said plurality of straps secures the feeder cover to a feeder.

8. The domed hay bale feeder according to claim 7, wherein said plurality of straps include a u-bolt, wherein u-bolt provides a means to attach and secure the strap along with the circular base unit to a feeder.
